(19) United States
(12) Patent Application Publication
(10) Pub. No.: US 2001/0048888 A1
(43) Pub. Date: Dec. 6, 2001

(54) Anti-scavenging solders for silver metallization and method

(76) Inventors: Rong-Fong Huang, Fremont, CA (US); Jian-Ku Shang, Champaign, IL (US); Ross A. Miesem, Albuquerque, NM (US)

Correspondence Address: Motorola, Inc., Intellectual Property Section, Law Department, PO Box 10219, Scotttsdale, AZ, 85271-0219, US

(21) Appl. No.: 09/825,706

(22) Filed: Apr. 4, 2001

Related U.S. Application Data
(63) Continuation-in-part of application No. 09/534,515, filed on Mar. 24, 2000, now abandoned.

(51) Int. Cl. B23K 31/00; C22C 13/00

(52) U.S. Cl. 420/558; 228/248.1; 420/557

(57) ABSTRACT

Solder and a method of manufacturing the solder are disclosed wherein powdered free silver is added to a solder alloy with a particle size sufficient to preserve silver metallization during use and with a concentration sufficient to maximize the effectiveness and avoid adverse effects on solder reflow characteristics. Preferably, the particle size is in a range of approximately 5 μm to 20 μm and the powdered free silver is added in a concentration of approximately 5% to 10%.

### FIELD OF THE INVENTION

This invention relates to apparatus and methods for improved silver metallization of electronic components and, more particularly, to apparatus and methods including anti-scavenging solders.

### BACKGROUND OF THE INVENTION

Silver metallization is widely used as the electrical conductor material in soldering or forming metal contacts for electronic components. During the initial soldering or formation and subsequent service (e.g. rework or reflow), tin in the solder alloy leaches or scavenges silver to cause loss of silver into the solder alloy, which degrades electrical performance and mechanical reliability of electronic components or devices. The dissolution of silver in the solder also makes it very difficult to rework or reflow the solder.

Current solutions to the silver scavenging problem generally include two methods or apparatus. The first is to use silver-alloyed metallization, the primary one being to replace pure silver with silver-palladium alloy. The second method or apparatus used to solve the problem is to increase the silver thickness in the metallization. Silver-palladium alloy has about one-tenth of the electrical conductivity of silver and, therefore, is not an ideal replacement for silver. In various electronic components and particularly ceramic substrates, the desired or ideal metallization thickness is approximately 10 micrometers. At this desired thickness, silver and silver-palladium metallizations were found to be nearly all consumed by a common silver-alloyed eutectic solder (62Sn-36Pb-2Ag). However, increasing the metallization thickness is not desirable because of the cost of the metal and the difficulty to maintain good adhesion with the component (e.g. with ceramic substrates).

Accordingly it is highly desirable to provide apparatus and a method for improving silver metallization, i.e. preventing silver scavenging, in electronic components which is inexpensive and easy to use.

### BRIEF DESCRIPTION OF THE DRAWINGS

Referring to the drawings

FIG. 1 is an X-ray map of silver distribution in a cross-section of a solder joint made between two metallizations in accordance with the present invention, after one reflow; and

FIG. 2 is a sectional view, similar to FIG. 1 illustrating the silver metallization after three reflows.

### DESCRIPTION OF THE PREFERRED EMBODIMENT

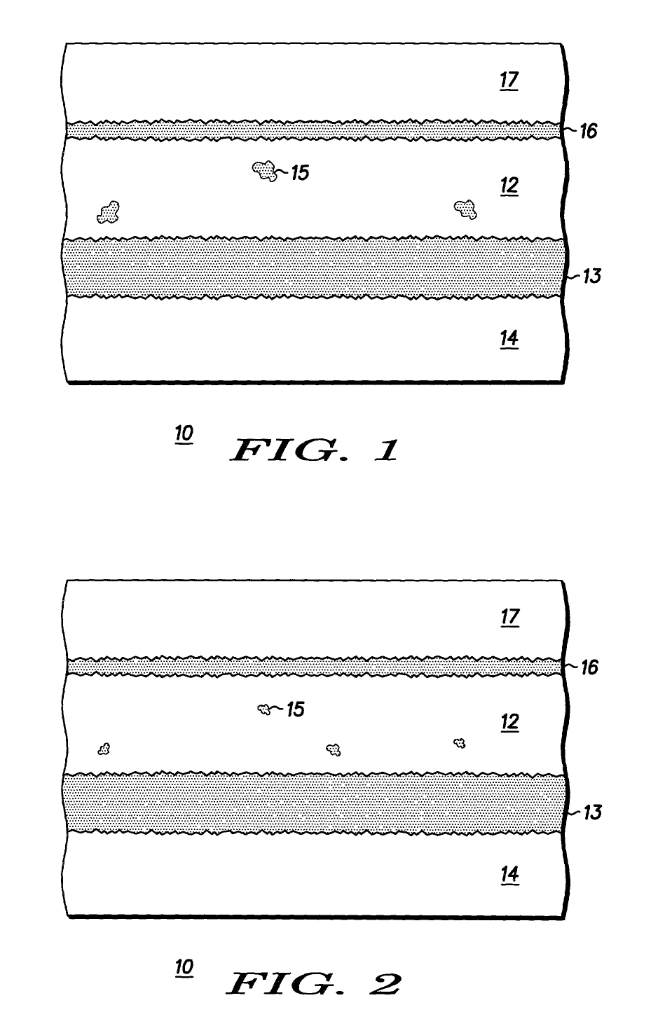

Turning now to the figures wherein like characters indicate like parts throughout the drawings, FIG. 1 is an X-ray map of silver distribution in a cross-section of a solder joint 10 made between two metallizations in accordance with the present invention. Solder joint 10 was formed by reflowing a solder alloy including powdered free silver. Illustrated in the X-ray map is a perferred embodiment comprising reflowed solder alloy 12 with copper metallization 13 positioned on a printed circuit board 14. Also included in the solder alloy 12 are remaining particles of free silver 15. A silver metallization layer 16 and a ceramic layer 17 are formed on the solder alloy 12. Additionally, FIG. 2 is a sectional view, similar to FIG. 1, illustrating solder joint 10 and copper metallization 13 after three reflows. It should be understood that other materials could be used, e.g., the metallization layer 13 could comprise silver.

Here it can be seen that the thickness of the original silver metallization, 8-10 μm, remains unchanged following the reflow, indicating that the silver leaching is stopped. Also, a few free silver particles 15 appear in solder joint 10 proving their effectiveness during subsequent reworks or reflows. Here it should be noted that free silver particles 15 in solder joint 10 also serve as a positive identification of the novel solder alloy including powdered free silver. Referring specifically to FIG. 2, it can be seen that after three reflows of solder joint 10 some free silver particles 15 still remain in solder alloy 12.

The novel anti-scavenging solder is manufactured by adding powdered free silver to a solder alloy. The free silver is added in a powder form to provide a high surface reactivity. Typical examples of common solder alloys that can be used include: 62Sn-36Pb-2AG; 95.5Sn-4.5Ag; and 96.5Sn-3.5AG. All of these common solders are supplied in a solid or pliable (e.g. paste) state for ease in application. The powdered free silver added to the solder alloy should have a particle size sufficient to preserve silver metallization during use. Too small a particle dissolves in the solder too quickly and too large a particle reacts with the solder alloy too slowly to preserve the silver metallization. Extensive tests show that the optimum size of the silver particles lies in a range of approximately 5 μm to 20 μm. It will of course be understood that a variation of a micron or two in particle size may be acceptable in some specific applications requiring less rigid standards.

Further, the powdered free silver added to the solder alloy should have a concentration sufficient to maximize the effectiveness and avoid adverse effects on solder reflow characteristics. Thus, the concentration of the free silver added to the solder alloy should be kept in a range which is sufficient to maximize the effectiveness of the free silver during reflow but which avoids adverse effects on solder reflow characteristics that occur with too high a free silver concentration. Extensive tests show that the optimum concentration of the silver particles lies in a range of approximately 5% to 10%. It will of course be understood that a variation of one or two per cent in particle concentration may be acceptable in some specific applications requiring less rigid standards.

Thus, in a preferred embodiment, silver scavenging in solder is substantially prevented, or silver metallization is improved, by providing a solder alloy and adding powdered free silver to the solder alloy with a particle size in a range of approximately 5 μm to 20 μm and a concentration of approximately 5% to 10%. Pull strength tests were performed on solder joints made with various combinations of particle size and concentration and the results indicate that in some instances the pull strengths increased while maintaining the desired or ideal metallization thickness at approximately 10 micrometers. The novel solder contains sufficient free silver particles to allow a good initial reflow and one or more subsequent reflows while maintaining the desired silver metallization and the required strength of the solder joint.

Thus, a new and improved anti-scavenging solder and method of manufacture is disclosed which maintains good adhesion with electronic substrates and especially ceramic substrates. Also, the new and improved anti-scavenging solder contains sufficient free silver particles to allow subsequent solder rework, and making it possible for the new solder to be reworked on silver metallization. Further, the new and improved anti-scavenging solder maintains electrical performance and mechanical reliability of electronic components or devices and the free silver particles in the solder makes one or more reworks or reflows of the solder possible.

While we have shown and described specific embodiments of the present invention, further modifications and improvements will occur to those skilled in the art. We desire it to be understood, therefore, that this invention is not limited to the particular forms shown and we intend in the appended claims to cover all modifications that do not depart from the spirit and scope of this invention.

What is claimed is:

1. Anti-scavenging solder comprising a solder alloy including powdered free silver.

2. Anti-scavenging solder as claimed in claim 1 wherein the solder alloy is in a paste state.

3. Anti-scavenging solder as claimed in claim 1 wherein the solder alloy includes powdered free silver with a particle size sufficient to preserve silver metallization during use.

4. Anti-scavenging solder as claimed in claim 1 wherein the solder alloy includes powdered free silver with a particle size in a range of approximately 5 μm to 20 μm.

5. Anti-scavenging solder as claimed in claim 1 wherein the solder alloy includes powdered free silver with a concentration sufficient to maximize the effectiveness and avoid adverse effects on solder reflow characteristics.

6. Anti-scavenging solder as claimed in claim 1 wherein the solder alloy includes powdered free silver in a concentratio n of approximately 5% to 10%.

7. A method of preventing silver scavenging in solder comprising the steps of:
providing a solder alloy; and
adding powdered free silver to the solder alloy.

8. A method of preventing silver scavenging in solder as claimed in claim 7 wherein the step of adding powdered free silver includes adding powdered free silver with a particle size sufficient to preserve silver metallization during use.

9. A method of preventing silver scavenging in solder as claimed in claim 7 wherein the step of adding powdered free silver includes adding powdered free silver with a particle size in a range of approximately 5 μm to 20 μm.

10. A method of preventing silver scavenging in solder as claimed in claim 7 wherein the step of adding powdered free silver includes adding powdered free silver with a concentration sufficient to maximize the effectiveness and avoid adverse effects on solder reflow characteristics.

11. A method of preventing silver scavenging in solder as claimed in claim 7 wherein the step of adding powdered free silver includes adding powdered free silver in a concentration of approximately 5% to 10%.

12. A method of preventing silver scavenging in solder comprising the steps of:
providing a solder alloy; and
adding powdered free silver to the solder alloy with a particle size in a range of approximately 5 μm to 20 μm and a concentration of approximately 5% to 10%.
